(19) United States
(12) Patent Application Publication
(10) Pub. No.: US 2012/0240619 A1
(43) Pub. Date: Sep. 27, 2012

(54) METHOD AND DEVICE FOR TREATING A CARBON-DIOXIDE-CONTAINING GAS FLOW, WHEREIN THE ENERGY OF THE VENT GAS (WORK AND COLD DUE TO EXPANSION) IS USED

(75) Inventors: Roland Ritter, Dresden (DE); Annett Kutzschbach, Dresden (DE)

(73) Assignee: LINDE-KCA-DRESDEN GmbH, Dresden (DE)

(21) Appl. No.: 13/393,566

(22) PCT Filed: Aug. 26, 2010
(86) PCT No.: PCT/EP2010/005248

§ 371 Date: May 9, 2012

(30) Foreign Application Priority Data
Sep. 3, 2009 (DE) 10 2009 039 898.8

(51) Int. Cl. F25J 3/00

(52) U.S. Cl. 62/617

(57) ABSTRACT

The invention relates to a method and a device for treating a carbon-dioxide-containing gas stream, in particular from a large-scale fired plant, e.g. from a power plant. The precompressed gas stream is separated in a carbon dioxide purification stage into a gas substream having an elevated carbon dioxide content (carbon dioxide product stream) and a gas substream having a decreased carbon dioxide content (vent gas stream). The carbon dioxide product stream is fed to further utilization and/or storage. In particular, by injecting the carbon dioxide underground, the emission of gases harmful to the climate can be reduced. For improving the energy efficiency, it is proposed that the vent gas stream is expanded in at least one expansion turbine and both the resultant kinetic energy and the resultant refrigeration are utilized for energy recovery. For utilizing the kinetic energy, the expansion turbine can be coupled to a compressor (booster) which compresses the crude gas stream and/or the carbon dioxide product stream. For utilizing the refrigeration generated in the expansion, the at least partially expanded vent gas stream can be brought into heat exchange with process streams which are to be cooled, e.g. the crude gas stream and/or the carbon dioxide product stream.

The invention relates to a method for treating a carbon-dioxide-containing gas stream, in particular from a large-scale fired plant, wherein the precompressed crude gas stream is separated in a carbon dioxide purification stage into a gas substream having an elevated carbon dioxide content (carbon dioxide product stream) and a gas substream having a reduced carbon dioxide content (vent gas stream), and the carbon dioxide product stream is fed to further use and/or storage, and also to a device for carrying out the method.

Carbon-dioxide-containing gas streams occur in all large-scale fired plants which are operated with fossil fuels such as coal, mineral oil or natural gas. These include, in particular, power plants, but also industrial furnaces, steam kettles and similar large thermal plants for generating power and/or heat. Furthermore, carbon-dioxide-containing gas streams are also formed in process plants of the chemical or petrochemical industry, such as, e.g., in cracking furnaces of olefin plants or in steam reformers of synthesis gas plants. Owing to the damaging effect of carbon dioxide gas on the climate, solutions are being sought in order to reduce the emissions of carbon-dioxide-containing exhaust gases into the atmosphere.

Recently, novel power plant concepts have been proposed in which the fossil fuel, e.g. coal, is burnt with an oxygen-rich combustion gas, in particular with technically pure oxygen or with oxygen-enriched air (oxygen fuel gas method). The oxygen proportion of this combustion gas is, e.g., 95 to 99.9% by volume. The resultant exhaust gas, which is also called flue gas, contains principally carbon dioxide (CO₂) at a proportion of approximately 70 to 85% by volume. The purpose of these novel concepts is to inject the carbon dioxide which is formed during the combustion of the fossil fuels and is present in concentrated form in the flue gas into suitable deposits, in particular into certain rock layers or brine-bearing layers, and thereby limit the carbon dioxide output to the atmosphere. The damaging effect of greenhouse gases such as carbon dioxide on the climate should be reduced thereby. Such power plants are termed in the specialist field “oxyfuel” power plants.

In the concepts known hitherto, in successive steps, the flue gas is dedusted, denitrified and desulphurized. Subsequently to this flue gas purification, the carbon-dioxide-rich exhaust gas thus prepared is compressed and fed to a carbon dioxide purification stage. There, a gas substream of reduced carbon dioxide content and another gas substream of elevated carbon dioxide content are generated, typically by a cryogenic separation method. The gas substream of elevated carbon dioxide content is the desired carbon dioxide product stream which occurs with a carbon dioxide content of, e.g., more than 95% by volume and is intended for further use, in particular for transport to deposits. The gas substream having a reduced carbon dioxide content occurs as a substream (called vent gas) at 15 to 30 bar, preferably 18-25 bar, and contains predominantly the components not intended for compression, in particular inert gases such as nitrogen (N₂) and argon (Ar) and also oxygen (O₂). In this gas substream, proportions of carbon dioxide are still present, however, at a concentration of approximately 25-35% by volume. This vent gas is currently ejected to the atmosphere.

Customarily, the crude gas stream is precompressed to pressure in upstream plant components and dried, e.g., in adsorber stations. This means that the vent gas also is at first still present in the compressed state. Currently this pressure level is lowered via expansion valves.

It has already been proposed in EP 1952874 A1 and EP 1953486 A1, after warming the vent gas and further heating by means of waste heat from the compression, to carry out a turbine expansion of the vent gas stream. Utilization of the energy liberated in the turbine expansion, in particular the refrigeration power occurring in the expansion process, is not provided in this case, however.

The object of the present invention is to configure a method of the type mentioned at the outset and also a device for carrying out the method in such a manner that the energy efficiency in obtaining the carbon dioxide product stream can be improved.

In terms of the process, this object is achieved by expanding the vent gas stream in at least one expansion turbine, wherein energy is recovered by utilizing not only the resultant kinetic energy but also the refrigeration generated in this process.

The consideration underlying the invention is to utilize the energy liberated on expansion of the vent gas stream for improving the energy efficiency of the overall process. The work-producing expansion of the vent gas in an expansion turbine offers the possibility of favourable energy recovery here.

For utilizing the kinetic energy, the expansion turbine is expediently coupled to at least one compressor (booster) such that the expansion turbine, during the at least partial expansion of the vent gas stream, compresses the crude gas stream and/or the carbon dioxide product stream. For utilizing the refrigeration generated in the expansion, the at least partially expanded vent gas stream is preferably brought into heat exchange with process streams which are to be cooled, e.g. the crude gas stream and/or the carbon dioxide product stream. By expanding the vent gas, in-process refrigeration power can be provided and thus external refrigeration can be dispensed with.

According to a particularly preferred embodiment of the invention, the vent gas stream is expanded stepwise in at least two expansion turbines. By means of the stepwise expansion of the vent gas stream, the formation of solid carbon dioxide in the vent gas can be reliably prevented. This is because, during the expansion of the vent gas from the compressed state to ambient pressure, the sublimation properties of the carbon dioxide should be noted. If, for a defined partial pressure of the carbon dioxide (dependent on the composition and expansion pressure of the vent gas), the temperature falls below the sublimation temperature, solid carbon dioxide forms. This limits the expansion pressure of the vent gas downstream of the expansion turbine owing to the attainment of the solid phase of the carbon dioxide, and the available pressure level of the vent gas cannot be completely utilized. The use of a single expansion turbine demands either powerful heating in the complete expansion, or only a partial expansion in order not to arrive at the carbon dioxide solid phase. By means of the stepwise expansion, in contrast, the entire pressure level can be exploited.

Advantageously, the vent gas stream, during stepwise expansion of the vent gas stream in at least two expansion turbines, in each case after one stage of expansion, is brought into heat exchange with process streams which are to be cooled, in particular the crude gas stream and/or the carbon dioxide product stream. In the case of a two-stage expansion, therefore, the vent gas stream, downstream of the expansion in the first expansion turbine, is expediently warmed in a heat transfer unit and then expanded further in the second expansion turbine to close to atmospheric pressure and again warmed in the heat transfer unit. The available pressure level of the vent gas can thereby be completely exploited.

The kinetic energy occurring during the expansion of the vent gas in the expansion turbine can, instead of for driving at least one compressor, also be used for driving at least one generator. The output generated in the expansion turbine can thereby be used for power generation.

In addition to the stepwise expansion in at least two expansion turbines, it is also possible only to employ one expansion turbine. In that case, however, the possible pressure level is not exploited and the residual expansion is carried out by means of an expansion valve. But here too, the refrigeration potential obtained is exploited in the heat transfer unit.

If there is a demand for very high product purities such as, for example, a decrease of the oxygen content in the carbon dioxide product stream, in particular in the case of injection in exhausted natural gas or mineral oil fields, but also on conversion to an industrial use, simple purification of the crude gas stream by separating off the carbon dioxide is no longer usable. In this case, a rectification column is integrated into the process. Here too, the vent gas can be expanded using a booster-braked expansion turbine or generator-braked expansion turbine, and the energy consumption thereby decreased.

The invention further relates to a device for treating a carbon-dioxide-containing gas stream (crude gas stream), in particular from a large-scale fired plant, having a carbon dioxide purification installation which is charged with the precompressed crude gas stream and has an outlet line for a gas substream of elevated carbon dioxide content (carbon dioxide product stream) and an outlet line for a gas substream of reduced carbon dioxide content (vent gas stream), wherein the outlet line for the carbon dioxide product stream is connected to a utilization installation and/or deposit.

The object in question is achieved in terms of the device in that the outlet line for the vent gas stream is connected to at least one expansion turbine which is coupled to at least one installation for utilizing the kinetic energy occurring in the expansion turbine and has an outlet line for the at least partially expanded vent gas stream which is at least in part expanded, which outlet line is connected to a heat transfer installation which can be charged with process streams which are to be cooled.

Preferably, the installation for utilizing the kinetic energy occurring in the expansion turbine is constructed as a compressor (booster) which can be charged with the crude gas stream and/or the carbon dioxide product stream.

Another advantageous variant provides that the installation for utilizing the kinetic energy occurring in the expansion turbine is constructed as a generator for power generation.

The invention is suitable for all conceivable large-scale fired plants in which carbon-dioxide-containing gas streams occur. These include, e.g., power plants operated with fossil fuels, industrial furnaces, steam kettles and similar large thermal plants for generating power and/or heat. Particularly advantageously, the invention can be used in large-scale fired plants which are supplied with technically pure oxygen or oxygen-enriched air as combustion gas and in which accordingly exhaust gas streams having high carbon dioxide concentrations occur. In particular, the invention is suitable for what are termed low-CO₂ coal-fired power plants which are operated using oxygen as combustion gas (“oxyfuel” power plants) and in which the carbon dioxide which is present in the exhaust gas in high concentration is separated off and injected underground (“CO₂ capture technology”).

A great number of advantages are associated with the invention:

By utilizing the liberated energy of the expansion turbine for driving the booster, immediate energy recycling takes place in the process. The crude carbon dioxide gas stream is recompressed in the booster. This compression energy can thereby be saved in the upstream crude gas compressor (if it is assumed that the same intermediate pressure is to be achieved). Likewise, the utilization of the liberated energy of the expansion turbine can be utilized for driving a booster for increasing the pressure of the carbon dioxide product stream. The available pressure level of the vent gas can be completely exploited.

By means of the stepwise expansion of the vent gas, in the central heat transfer unit, refrigeration power can be provided from in-process resources. The use of external refrigeration can thereby be dispensed with or decreased.

In addition, by means of the stepwise expansion of the vent gas, the resultant cooling of the carbon-dioxide-containing vent gas can proceed in such a manner that the risk of the temperature falling below the sublimation temperature is avoided. This prevents solid carbon dioxide (dry ice) from forming, precipitating out and thus disrupting the process.

The invention and also other embodiments of the invention will be described in more detail hereinafter with reference to exemplary embodiments shown diagrammatically in the figures in comparison with the previous prior art.

In the drawings:

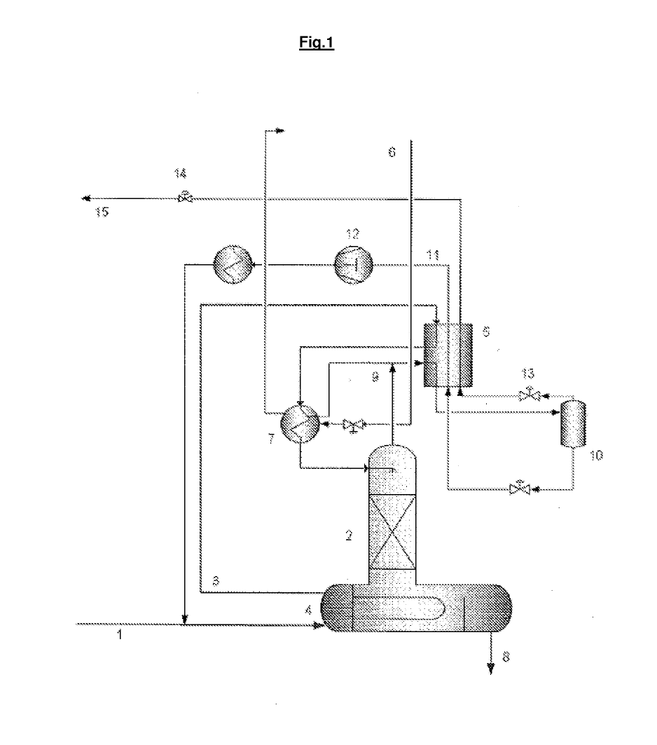

FIG. 1 shows a block diagram of a carbon dioxide treatment plant with expansion of the vent gas via expansion valves according to the prior art for high purities of the carbon dioxide product stream

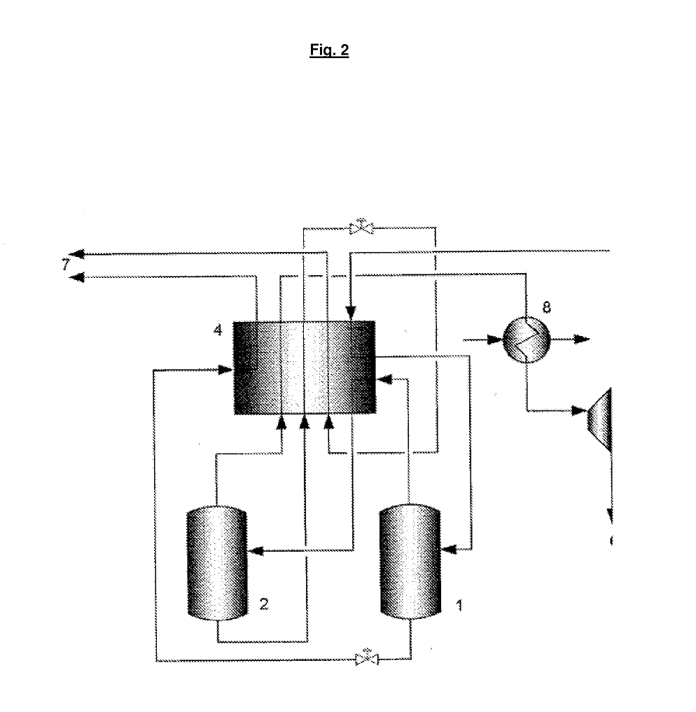

FIG. 2 shows a block diagram of a carbon dioxide treatment plant with expansion of the vent gas via a turbine according to the prior art

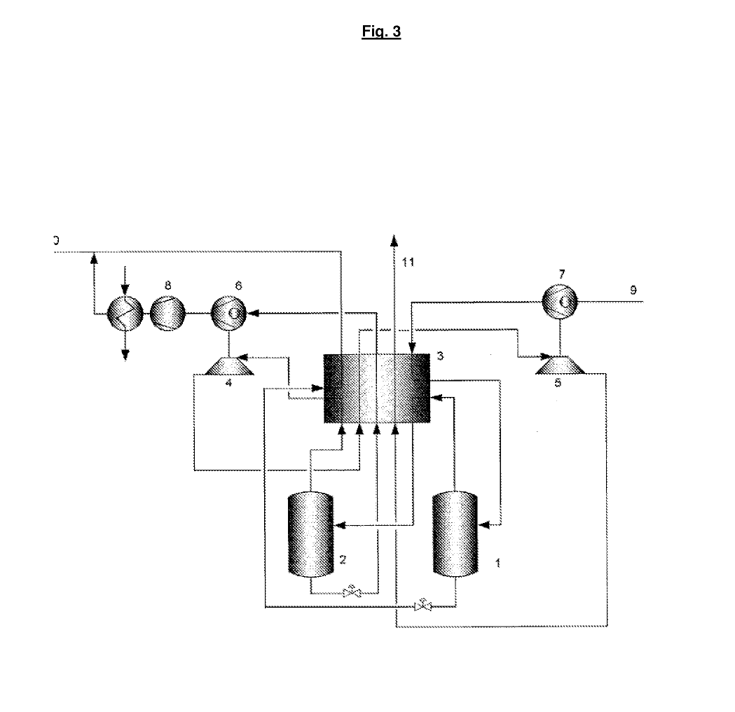

FIG. 3 shows a block diagram of a carbon dioxide treatment plant having stepwise expansion of the vent gas via booster-braked expansion turbines with energy recovery according to the invention

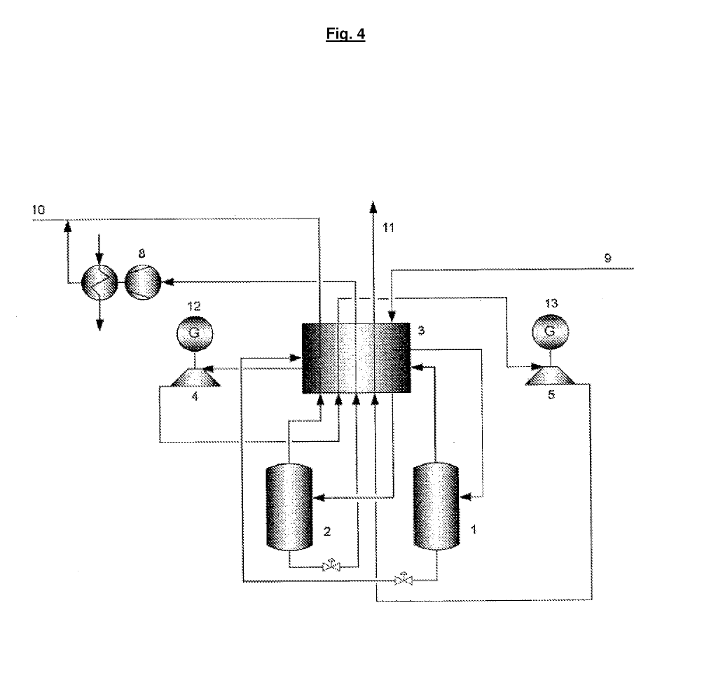

FIG. 4 shows a block diagram of a carbon dioxide treatment plant having stepwise expansion of the vent gas via generator-braked expansion turbines with energy recovery according to the invention

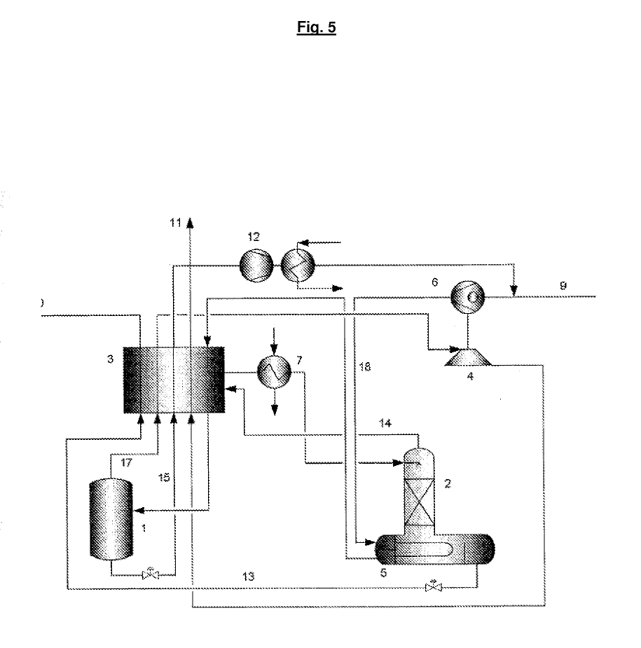

FIG. 5 shows a block diagram of a carbon dioxide treatment plant with a rectification column for achieving high carbon dioxide product purities and expansion of the vent gas via a booster-braked expansion turbine with energy recovery according to the invention

FIG. 1 shows conventional processing of a carbon-dioxide-containing crude gas stream from a coal-fired power plant according to the prior art for obtaining high carbon dioxide product purities. The crude gas stream, after precompression and drying which are not shown in the figure, is fed via line (1) to a rectification column (2) in which the majority of the carbon dioxide is separated off from the crude gas. For this purpose, crude gas and recirculated enriched carbon dioxide gas are passed via line (3) from the reboiler of the rectification column (4) to the top of the rectification column (2) via a heat exchanger (5) and a liquefier (7) supplied with refrigerant via line (6). The resultant carbon dioxide product stream which is highly enriched with carbon dioxide is taken off from the rectification column (2) via line (8) and can be fed, e.g., to an underground injection, or a CO₂ liquid store. The vent gas which is low in carbon dioxide is taken off from the rectification volume (2) via line (9) and fed via the heat exchanger (5) to a carbon dioxide separator (10) in which the vent gas is substantially freed from carbon dioxide which is still present. The carbon dioxide which is separated off is taken off from the bottom of the carbon dioxide separator and recirculated to the rectification column (2) via line (11) and a reflux compressor (12). The vent gas which has been substantially freed from carbon dioxide is taken off from the top of the carbon dioxide separator (10), pre-expanded in an expansion valve (13), subsequently passed through the heat exchanger (5) and finally expanded in a second expansion valve (14) and released to the atmosphere.

The variant of the prior art shown in FIG. 2 differs from that shown in FIG. 1 in that, instead of a rectification column, two carbon dioxide separators (1) and (2) are provided for separating the crude gas which is fed via line (3), after cooling and partial condensation in the central heat transfer unit (4), into the carbon dioxide product stream and the vent gas which is low in carbon dioxide. The carbon dioxide product stream is taken off in each case from the bottom of the carbon dioxide separators (1, 2) and fed via a central heat transfer unit (4) to a product compression (7) which is not shown, in order finally to be, e.g., injected underground. The vent gas is taken off in each case from the top of the carbon dioxide separators (1, 2), likewise passed via the central heat transfer unit (4) and finally, after further heating in the heat transfer unit (8), expanded via a turbine (5) in order to be released to the atmosphere (6). Such a procedure is described, e.g., in EP 1952874 A1.

In contrast to the methods shown in FIGS. 1 and 2 for carbon dioxide processing according to the prior art, the exemplary embodiments of the present invention, shown in FIGS. 3 to 5, offer the advantage of energy recovery in the expansion of the vent gas.

In the exemplary embodiment of the invention shown in FIG. 3, as in the variant of the prior art shown in FIG. 2, two carbon dioxide separators (1) and (2) and also a central heat transfer unit (3) are provided. However, in contrast to the prior art, a simple expansion of the vent gas via a single turbine is not performed, but rather a stepwise expansion via two expansion turbines (4) and (5) which drive compressors (boosters) (6) and (7) which compress the crude gas stream and the carbon dioxide product stream. The energy which is liberated in the expansion of the vent gas in the expansion turbines (4) and (5) can be recovered efficiently in this process. The way in which this arrangement works may be described as follows:

Booster (6) is driven by the liberated energy of the expansion turbine (4). By means of the booster (6), the carbon dioxide product stream at the lower pressure coming from the carbon dioxide separator (2) can first be precompressed to the higher pressure of the carbon dioxide product stream coming from the other carbon dioxide separator (1) and increased to the pressure level via a further compressor (8). The second booster (7) is driven by the liberated energy of the second expansion turbine (5). With this booster (7), the crude gas coming via line (9) from the drying and precompression, which are not shown, can be compressed to a higher pressure. By means of the stepwise expansion of the vent gas stream, the formation of solid carbon dioxide in the vent gas can be prevented. After the expansion in the first expansion turbine (4), the vent gas stream is warmed in the central heat transfer unit (3) and then further expanded close to atmospheric pressure in the second expansion turbine (5) and again warmed in the central heat transfer unit (3). The available pressure level of the vent gas can be completely exploited thereby. The cold vent gas after the expansion is warmed in the central heat transfer unit against the process streams which are to be cooled. The vent gas thereby provides some of the refrigeration power required in the process.

FIG. 4 shows a variant of the exemplary embodiment of FIG. 3, which differs therefrom in that the expansion turbines (4) and (5), instead of driving compressors (boosters), drive generators (12) and (13) for power generation. Energy recovery can also be made possible thereby.

Finally, FIG. 5 shows another variant of the invention in which, for example because of the requirement of high product purities, instead of carbon dioxide separators, a rectification column (2) is provided for separating off the carbon dioxide from the crude gas. In this case the crude gas which is fed via line (9), via the central heat transfer unit (3) and liquefier (7), is separated in the rectification column (2) into a carbon-dioxide-rich carbon dioxide product stream which is taken off from the bottom of the rectification column (2) and a vent gas stream which is low in carbon dioxide and is taken off from the top of the rectification column (2). The carbon dioxide product stream is passed by means of line (13) via the central heat transfer unit (3) and can, after product compression (10), be fed, e.g., to underground injection. The vent gas is fed by means of line (14) likewise via the central heat transfer unit (3) and delivered to a separator (1) where it is substantially freed from remaining carbon dioxide. The carbon dioxide which is separated off is taken off from the bottom of the separator (1) and added via line (15) and a reflux compressor (12) to the crude gas feed. The vent gas which is substantially carbon-dioxide-free is taken off from the top of the separator (1) and fed by means of line (17) via the central heat transfer unit (3) to the expansion turbine (4). The expansion turbine (4) drives a booster (6) which compresses the crude gas. The crude gas which is warmed in this process is utilized via line (18) for the heating in the reboiler (5) of the rectification column (2). The vent gas which is expanded in the expansion turbine (4) is finally released to the atmosphere (11) via the central heat transfer unit (3).

1. Method for treating a carbon-dioxide-containing gas stream (crude gas stream), in particular from a large-scale fired plant, wherein the precompressed crude gas stream is separated in a carbon dioxide purification stage into a gas substream having an elevated carbon dioxide content (carbon dioxide product stream) and a gas substream having a reduced carbon dioxide content (vent gas stream), and the carbon dioxide product stream is fed to further use and/or storage, characterized in that the vent gas stream is expanded in at least one expansion turbine, wherein energy is recovered by utilizing not only the resultant kinetic energy but also the refrigeration generated in this process.

2. Method according to claim 1, characterized in that the vent gas stream is expanded stepwise in at least two expansion turbines.

3. Method according to claim 1, characterized in that the expansion turbine drives at least one compressor (booster) which compresses the crude gas stream and/or the carbon dioxide product stream.

4. Method according to claim 1, characterized in that the expansion turbine drives at least one generator for power generation.

5. Method according to claim 1, characterized in that the vent gas stream which is expanded in the expansion turbine is brought into heat exchange with process streams which are to be cooled, in particular the crude gas stream and/or the carbon dioxide product stream.

6. Method according to claim 2, characterized in that the vent gas stream, during stepwise expansion of the vent gas stream in at least two expansion turbines, in each case after one stage of expansion, is brought into heat exchange with process streams which are to be cooled, in particular the crude gas stream and/or the carbon dioxide product stream.

7. Method according to claim 1, characterized in that the carbon dioxide purification stage comprises a rectification column

8. Device for treating a carbon-dioxide-containing gas stream (crude gas stream), in particular from a large-scale fired plant, having a carbon dioxide purification installation which is charged with the precompressed crude gas stream and has an outlet line for a gas substream of elevated carbon dioxide content (carbon dioxide product stream) and an outlet line for a gas substream of reduced carbon dioxide content (vent gas stream), wherein the outlet line for the carbon dioxide product stream is connected to a utilization installation and/or deposit, characterized in that the outlet line for the vent gas stream is connected to at least one expansion turbine which is coupled to at least one installation for utilizing the kinetic energy occurring in the expansion turbine and has an outlet line for the at least partially expanded vent gas stream, which outlet line is connected to a heat transfer installation which can be charged with process streams which are to be cooled.

9. Device according to claim 8, characterized in that the installation for utilizing the kinetic energy occurring in the expansion turbine is constructed as a compressor (booster) which can be charged with the crude gas stream and/or the carbon dioxide product stream.

10. Device according to claim 8, characterized in that the installation for utilizing the kinetic energy occurring in the expansion turbine is constructed as a generator for power generation.
